(19) United States
(12) Patent Application Publication
(10) Pub. No.: US 2023/0067134 A1
(43) Pub. Date: Mar. 2, 2023

(54) CYLINDER HEATING DEVICE OF CONDUIT FORMING SYSTEM USING WASTE SYNTHETIC RESIN

(71) Applicants: Yu Kyung CHO, Ulsan (KR); GPR SK Co., Ltd., Busan (KR); WES TEC GLOBAL CO., LTD., Yongin-si (KR)

(72) Inventors: Kyoung Young CHOI, Yongin-si (KR); CHUN-DAL HWANG, Gimhae-si (KR)

(73) Assignees: Yu Kyung CHO, Ulsan (KR); GPR SK Co., Ltd., Busan (KR); WES TEC GLOBAL CO., LTD., Yongin-si (KR)

(21) Appl. No.: 17/465,411

(22) Filed: Sep. 2, 2021

(51) Int. Cl. B29B 17/00; B29B 17/04

(52) U.S. Cl. CPC B29B 17/0005; B29B 17/04; B29K 2105/26

(57) ABSTRACT

Disclosed is a cylinder heating device of a conduit forming system using waste synthetic resin, in which a pipe type unit heater is used rather than a bend type heater to prevent heat loss during heat transfer to a cylinder so that waste synthetic resin in the first and second space parts in the cylinder is melted within a short time as well as the quality of a formed conduit is improved.

### BACKGROUND

The present invention relates to a conduit forming system using waste synthetic resin and, more particularly, to a cylinder heating device of a conduit forming system using waste synthetic resin, in which heat is applied to a cylinder so that waste synthetic resin can be melted inside the cylinder.

In general, various waste synthetic resins thrown away at industrial sites are buried in landfill or incinerated, which causes pollution of the surrounding environment. When the waste synthetic resin is buried, it does not rot or decompose in the soil, thus devastating the soil, and the waste synthetic resin is incinerated, various harmful gases are discharged, causing serious air pollution.

In particular, recently, waste synthetic resin is treated with incineration as the easiest treatment method and in this case, as it is known that a deadly toxin called dioxin is released, there is an urgent need for a countermeasure. Accordingly, not only the central government but also each local government recycle waste generously support waste synthetic resin recycling technologies rather than landfilling or incineration so as to produce products that do not have any major problems in use, even if the quality is slightly lower. In line with this, it is spurring in the related industrial fields the development of technologies for using waste synthetic resin by melting it by heating and then re-forming it into various synthetic resin products. As one of them, there is a technology for forming a conduit to be used as a passage for sewage or wastewater in an industrial site, and it could be understood that a conduit forming system is required to form such a conduit.

Meanwhile, conduits are manufactured using such a conduit forming system by sequentially performing the preparation step of selectively washing and cutting waste synthetic resin as necessary, the moving step of receiving the prepared waste synthetic resin and moving it from one side to the other, the heating step of melting the moved waste synthetic resin into a liquid state by heat, the discharging step of discharging the molten liquid waste synthetic resin liquid, the molding step of receiving the discharged waste synthetic resin in the molten state and molding it into a conduit in the mold of a molding machine, the separating step of separating the molded conduit from the mold, and the transferring step of picking up the separated conduit and moving it to a loading box.

Herein, in the conduit forming system using waste synthetic resin, the components of the moving step for receiving the waste synthetic resin and moving the same from one side to the other, the components of the heating step for melting the moving waste synthetic resin into a liquid state by applying heat, and the components of the discharging step of discharging the molten liquid waste synthetic resin liquid are considered as a single system as follows.

The conduit forming system using waste synthetic resin includes a cylinder 1 in the form of a metal tube, inside which a first space part 1a and a second space part 1b are connected to each other in a horizontal state and are provided to communicate with each other, a hopper 2 integrally formed on top of the inlet side of the cylinder so as to inject waste synthetic resin into the cylinder 1 through this hopper 2 from the outside, a first rotation screw 3, which is rotatably and axially coupled to the first space part 1a in the cylinder 1 and receives the driving force of a motor through a power transmission means so as to apply moving force towards an outlet side to the waste synthetic resin injected into the cylinder 1 while primarily rotating, a second rotation screw 4, which is rotatably and axially coupled to the second space part 1b in the cylinder 1 and receives the rotational force of the first rotation screw 3 through a rotational force transmission means so as to apply, together with the first rotation screw 3, moving force towards the outlet side to the waste synthetic resin while secondarily rotating, a heater 5, which is provided on the outside of the cylinder 1 and thus heats the cylinder so as to enable the waste synthetic resin to be molten into a liquid state, which is moved from the inlet side to the outlet side in the cylinder 1 through the rotation of the first and second rotation screws 3 and 4, and an outlet 6 integrally formed at the lower portion of the outlet side of the cylinder 1 so that the liquid waste synthetic resin liquid is discharged to the outside of the cylinder 1 according to the rotation of the first and second rotation screws 3 and 4, wherein the cylinder 1 is positioned at a predetermined height so as to be spaced apart from the ground by a base 7.

Therefore, when an operator operates the conduit forming system using waste synthetic resin, the first rotation screw 3 rotatably and axially coupled to the first space part 1a in the cylinder 1 receives the driving force of the motor which is not shown through the power transmission means and rotates clockwise in the drawings, and accordingly the second rotation screw 4 receives the rotational force of the first rotation screw 3 through another power transmission means and rotates counterclockwise in the drawings, wherein the heater 5 provided on the outside of the cylinder 1 operates to heat the cylinder 1 at the same time.

In this state, if the operator carries out the steps such as washing and/or cutting the collected waste synthetic resin and then inserts the waste synthetic resin into the cylinder 1 through the hopper 2 formed at the upper inlet side of the cylinder 1, the waste synthetic resin moves from the inlet side to the outlet side due to the inclination angle of the screw blades of the first rotation screw 3 rotating in the first space part 1a and the second rotation screw 4 rotating in the second space part 1b in the cylinder 1. Herein, since the cylinder 1 is heated by the heater 5, the waste synthetic resin moving to the outlet side in the cylinder 1 is melted by heat and turned into a liquid state. This liquid waste synthetic resin moves to the outlet side while being mixed due to the continuous rotation of the first and second rotation screws 3 and 4, and then is discharged through the outlet 6 formed in the lower portion of the outlet side of the cylinder 1.

Meanwhile, the waste synthetic resin in the liquid state that has been discharged from the cylinder 1 through the above steps enters the mold in the molding machine as described above and is molded into a conduit through the conduit molding step, the molded conduit is separated from the mold through the separating step, the separated conduit is picked up by a pickup means and transferred to the loading box through the transferring step, and thus all the process of the conduit forming system using waste synthetic resin is finished.

In the conduit forming system described above, a plurality of bend-type heaters 51 are used as the conventional heater 5, which is a component for heating the cylinder 1 so that the waste synthetic resin in the cylinder 1 is melted by heat, wherein the plurality of bend-type heaters 51 are provided, as shown in FIG. 4 and FIG. 5, on the outside of the cylinder 1 in a contact state in the circumferential direction at a predetermined interval in the longitudinal direction. The bend-type heater includes a heater body 51a that actually generates electrical heat and a bend clip 51b that tightly surrounds the heater body so that the heater body is not separated from the cylinder 1.

However, the heater 5 in the conventional cylinder heating device is a bend-type heater 51 of which the heater body 51a is provided on the outside of the cylinder 1 in a contact state from the outside in the circumferential direction.

Therefore, when considering the appearance of the cylinder 1, in which the upper and lower portions are curved in the center so that the first space part 1a and the second space part 1b are provided in a horizontal state, the centers of the upper and lower middle portions of the cylinder 1 inevitably have a gap A spaced apart from the heater body 51a even if the heater body 51a is tightly wrapped with the bend clip 51b. In this case, the heat of the heater body 51a is not transferred to the cylinder 1 to a certain extent and thus heat exchange is carried out with the outside air in the gap A.

Consequently, there is a primary problem that the waste synthetic resin cannot be completely melted in a short time in the first and second space parts 1a and 1b inside the cylinder 1 because the heat transfer power to the cylinder 1 is reduced, resulting in a secondary problem that the quality of the molded conduit is deteriorated.

In addition, if the bend-type heater 51 is damaged due to long-term use, the entire bend-type heater 51 that is expensive needs to be replaced, thereby increasing maintenance costs. Moreover, depending on the type of the waste synthetic resin inputted in the process of use, even if a specific portion of the cylinder 1 is desired to be selected as a heating portion in the circumferential direction of the cylinder 1, this could not be carried out, so there is a further problem of inconvenience in use.

### PRIOR ART DOCUMENTS

### Patent Documents

[Patent Document 1] Korean Utility Model Application No. 20-1997-0002338 filed on Feb. 13, 1997 (Publication No. 20-1998-0058002 U published on Oct. 16, 1998)

[Patent Document 2] Korean Utility Model Application No. 20-2003-0014821 filed on May 14, 2003 (Utility Registration No. 20-0324423 Y1 published on Aug. 25, 2003)

[Patent Document 3] Korean Patent Application No. 10-2003-0072922 filed on Oct. 20, 2003 (Publication No. 10-2005-0037686 A published on Apr. 25, 2005)

[Patent Document 4] Korean Patent Application No. 10-2009-0103986 filed on Oct. 20, 2009 (Publication No. 10-2011-0047385 A published on May 9, 2011)

### SUMMARY

The present invention is derived to solve the problems as described above and has an objective to provide a cylinder heating device of a conduit forming system using waste synthetic resin, in which a pipe type unit heater is used rather than a bend type heater to prevent heat loss during heat transfer to a cylinder so that waste synthetic resin in the first and second space parts in the cylinder is melted within a short time so as to improve the quality of a formed conduit. In addition, a heating part of the cylinder may be partially selected in the circumferential direction according to the type of synthetic resin to be regenerated, thereby providing convenience in use.

In order to achieve the above described objectives of the present invention, there is provided in a conduit forming system using waste synthetic resin, in which a heater heats a cylinder in the form of a metal tube, in which a first space part and a second space part communicate with each other, so as to melt waste synthetic resin into a liquid state in the first and second space parts in the cylinder, a cylinder heating device of a conduit forming system using waste synthetic resin, characterized in that the heater is a pipe type unit heater, a plurality of heater insertion grooves are formed around the outer circumference of the cylinder at a predetermined interval in the circumferential direction of the cylinder and at a predetermined distance in the longitudinal direction of the cylinder, a pipe type unit heater is inserted into each heater insertion groove, and a heater cover is detachably coupled by a screw to the outer circumference of the cylinder so as to prevent the pipe type unit heater inserted into each heater insertion groove from being separated from each heater insertion groove and prevent the heat generated from the pipe type unit heater from escaping to the outside.

In addition, the pipe type unit heater is formed so that one end of a portion inserted into the heater insertion groove extends and is bent at a right angle (L-shape), and the heater cover coupled to the outer circumference of the cylinder is formed with a through hole so as to avoid interference of the extension portion of the one end of the pipe type unit heater so that a power supply line can be connected from the outside of the cylinder through the extension portion of the one end of the pipe type unit heater even when the heater cover is coupled to the outer circumference of the cylinder.

As for the cylinder heating device of a conduit forming system using waste synthetic resin, according to the present invention described hereinabove, even if a part of the exterior of the cylinder is curved so that the cylinder has a first space part and a second space part, the heater for transferring heat to the cylinder is a pipe type unit heater and has a coupling structure, in which the heater is inserted into a heater insertion groove formed in the longitudinal direction around the outer circumference of the cylinder, so that there is no effect of the curvature, which is the external shape of the cylinder. In addition, since the contact area between the pipe type unit heater and the cylinder is increased, the thermal conductivity of the cylinder is increased by the heater so that the waste synthetic resin is rapidly melted in the cylinder, thereby improving the quality of the conduit during the conduit molding.

Moreover, according to the present invention, when the pipe type unit heater damaged due to long-term use and thus needs to be replaced, only the damaged pipe type unit heater can be selected and replaced quickly. Therefore, considering that the pipe type unit heater is relatively inexpensive, the maintenance costs is reduced. Also, depending on the type of waste synthetic resin inputted in the process of use, the heating portion of the cylinder can be selectively adjusted in the circumferential direction of the cylinder, thereby ensuring the convenience of use.

### BRIEF DESCRIPTION OF THE DRAWINGS

FIG. 1 is a front view of the main part of a conduit forming system using waste synthetic resin with a conventional cylinder heating device.

FIG. 2 is a longitudinal cross-sectional view of a conduit forming system using waste synthetic resin with a conventional cylinder heating device.

FIG. 3 is a cross-sectional view of the main part of a conduit forming system using a waste synthetic resin with a conventional cylinder heating device.

FIG. 4 is a perspective view of the main part of the conduit forming system using a waste synthetic resin with a conventional cylinder heating device.

FIG. 5 is an enlarged cross-sectional view of the main part shown in FIG. 4 seen from the side.

FIG. 6 is a perspective view of the main part of a conduit forming system using waste synthetic resin with a cylinder heating device according to the present invention, and

FIG. 7 is an enlarged cross-sectional view of the main part shown in FIG. 6 seen from the side.

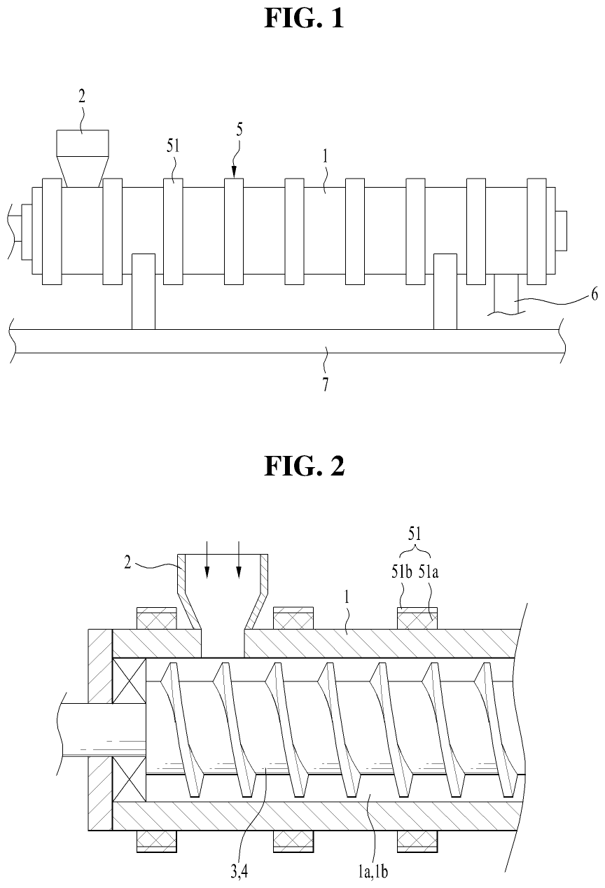

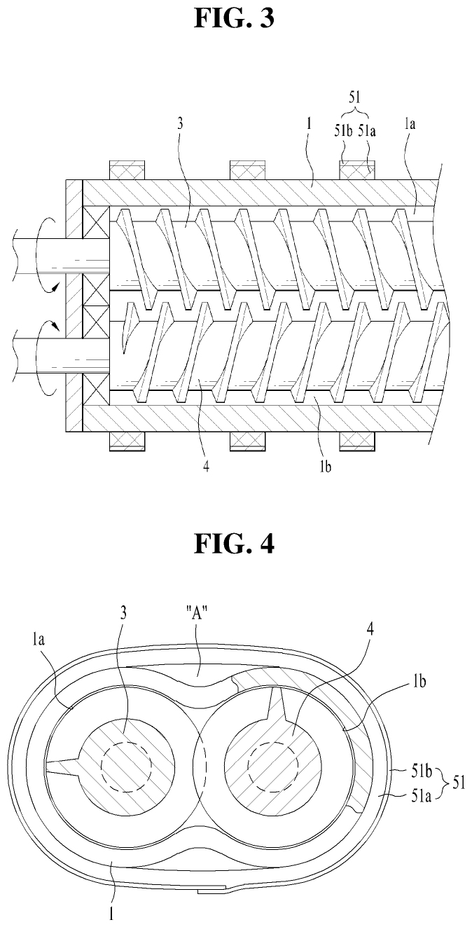

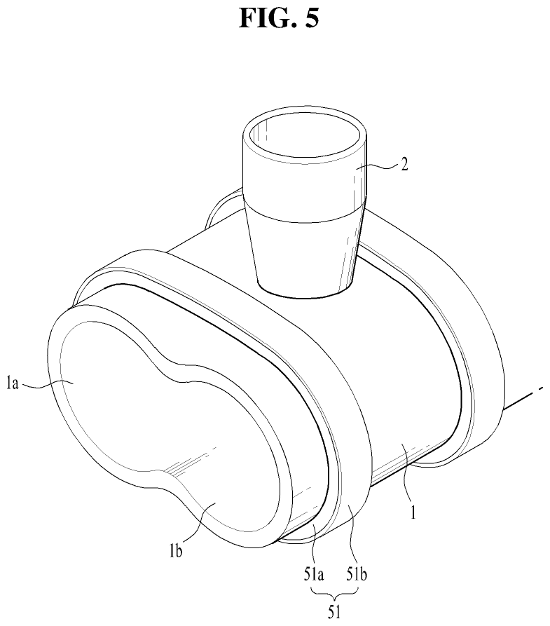

### DETAILED DESCRIPTION

Hereinafter, preferred embodiments according to the present invention will be described with reference to the accompanying drawings.

The embodiments of the present invention may be modified in various forms and it should not be construed that the scope of the present invention is limited to the embodiments described in detail below. The embodiments of the present invention are provided to more completely explain the present invention to those of ordinary skill in the art.

Therefore, in the drawings, the shape of elements may be exaggerated to emphasize a clearer description. Detailed descriptions of well-known functions and configurations determined to unnecessarily obscure the gist of the present invention will be omitted.

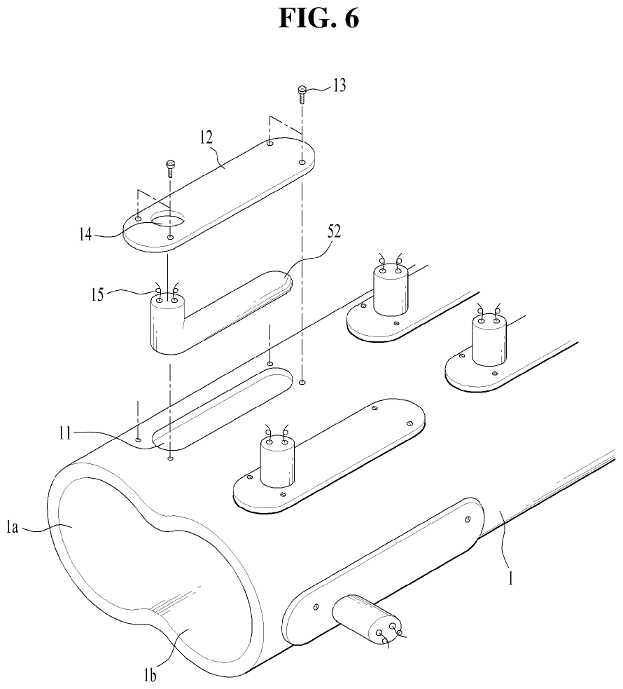

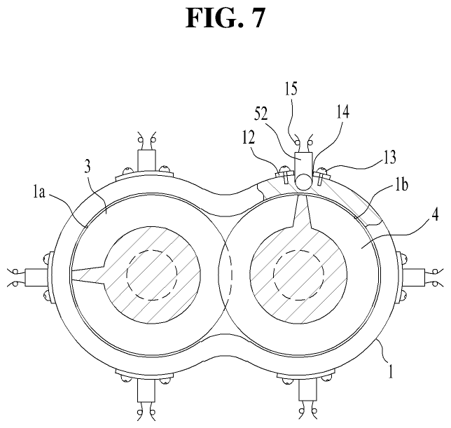

As shown in FIG. 6 and FIG. 7, according to the present invention, in a conduit forming system using waste synthetic resin, which includes a cylinder 1 in the form of a metal tube, in which a first space part 1a and a second space part 1b are provided so as to communicate with each other, a hopper 2 integrally formed on top of the inlet side of the cylinder so as to inject waste synthetic resin into the cylinder 1 through this hopper 2 from the outside, a first rotation screw 3, which is rotatably and axially coupled to the first space part 1a in the cylinder 1 and receives the driving force of a motor (not shown) through a power transmission means so as to while primarily rotating apply moving force towards an outlet side to the waste synthetic resin injected through the hopper 2 into the cylinder 1, a second rotation screw 4, which is rotatably and axially coupled to the second space part 1b in the cylinder 1 and receives the rotational force of the first rotation screw 3 through a rotational force transmission means so as to while secondarily rotating apply, together with the first rotation screw 3, moving force towards the outlet side to the waste synthetic resin, a heater 5, which is provided on the outside of the cylinder 1 and thus heats the cylinder so as to enable the waste synthetic resin to be molten into a liquid state, which is moved from the inlet side to the outlet side in the cylinder 1 through the rotation of the first and second rotation screws 3 and 4, and an outlet 6 integrally formed at the lower portion of the outlet side of the cylinder 1 so that the liquid waste synthetic resin liquid is discharged to the outside of the cylinder 1 according to the rotation of the first and second rotation screws 3 and 4, wherein the heater 5 is a pipe type unit heater 52, a plurality of heater insertion grooves 11 are formed around the outer circumference of the cylinder 1 at a predetermined interval in the circumferential direction of the cylinder and at a predetermined distance in the longitudinal direction of the cylinder 1, a pipe type unit heater 52 is inserted into each heater insertion groove, and a heater cover 12 is detachably coupled by a fixing screw 13 to the outer circumference of the cylinder 1 so as to prevent the pipe type unit heater 52 inserted into each heater insertion groove 11 from being separated from each heater insertion groove 11 and prevent the heat generated from the pipe type unit heater from escaping to the outside.

In addition, the pipe type unit heater 52 is formed so that one end of a portion inserted into the heater insertion groove 11 extends and is bent at a right angle L-shape, and the heater cover 12 coupled to the outer circumference of the cylinder 1 is formed with a through hole 14 so as to avoid interference of the extension portion of the one end of the pipe type unit heater 52 so that a power supply line 15 can be connected from the outside of the cylinder 1 through the extension portion of the one end of the pipe type unit heater 52 even when the heater cover 12 is coupled to the outer circumference of the cylinder 1.

The coupling process of the pipe type unit heater 52 among the components of the cylinder heating device according to an embodiment of the present invention will be described hereinafter for reference.

When the pipe type unit heater 52 is inserted into the heater insertion groove 11 formed on the outside of the cylinder 1, one side portion of the pipe type unit heater, which is bent at a right angle, is exposed and protrudes from the outer circumference of the cylinder, but the remaining portions are all accommodated in the heater insertion groove 11.

In this state, the heater cover 12 is brought into contact with the outer circumferential surface of the cylinder 1 while allowing the perpendicularly bent portion of the pipe type unit heater 52 to be inserted through the through hole 14 formed in the heater cover 12. Then, when the heater cover 12 is fixed to the cylinder 1 with the fixing screw 13, the coupling of the pipe type unit heater 52 is completed. In this state, the actual heat generating portion of the pipe type unit heater 52 is covered by the heater cover 12 so as not to be seen from the outside.

In this state, when the power supply line 15 for supplying power is connected to the bent portion of the pipe type unit heater 52, which is exposed to the outside of the cylinder 1, the coupling of the cylinder heating device according to an embodiment of the present invention is completed.

When a conduit is formed using waste synthetic resin in the state where the coupling of the cylinder heating device of the present invention is completed, power is transmitted to each pipe type unit heater 52 through the power supply line 15 so that each pipe type unit heater generates heat in each heater insertion groove 11 formed on the cylinder 1. Since the heat is transferred to the cylinder 1 as it is, as the cylinder heats up, the waste synthetic resin moved from the inlet side to the outlet side is melted in the first and second space parts 1a and 1b while the first rotation screw 3 and the second rotation screw 4 are engaged with each other and thus rotate in the first space part 1a and second space part 1b in the cylinder 1.

Meanwhile, since the heat generated by the pipe type unit heater 52 in the above process cannot easily escape to the outside of the cylinder 1 due to the heater cover 12, the amount of the heat transferred to the cylinder 1 substantially increases that much.

In addition, according to the present invention, when an abnormality occurs during the use of several pipe type unit heaters 52 and the pipe type unit heaters 52 need to be replaced, only the fixing screw 13 that connects the heater cover 12 to the cylinder 1 is separated by simply using a tool such as a screwdriver. Therefore, it may be understood that maintenance becomes very convenient.

What is claimed is:

1. In a conduit forming system using waste synthetic resin, in which a heater heats a cylinder in the form of a metal tube, in which a first space part and a second space part communicate with each other, so as to melt waste synthetic resin into a liquid state in the first and second space parts in the cylinder, a cylinder heating device of a conduit forming system using waste synthetic resin, characterized in that
the heater is a pipe type unit heater,
a plurality of heater insertion grooves are formed around the outer circumference of the cylinder at a predetermined interval in the circumferential direction of the cylinder and at a predetermined distance in the longitudinal direction of the cylinder,
a pipe type unit heater is inserted into each heater insertion groove, and
a heater cover is detachably coupled by a screw to the outer circumference of the cylinder so as to prevent the pipe type unit heater inserted into each heater insertion groove from being separated from each heater insertion groove and prevent the heat generated from the pipe type unit heater from escaping to the outside.

2. The cylinder heating device of conduit forming system using waste synthetic resin according to claim 1, wherein
the pipe type unit heater is formed so that one end of a portion inserted into the heater insertion groove extends and is bent at a right angle (L-shape), and
the heater cover coupled to the outer circumference of the cylinder is formed with a through hole so as to avoid interference of the extension portion of the one end of the pipe type unit heater so that a power supply line can be connected from the outside of the cylinder through the extension portion of the one end of the pipe type unit heater even when the heater cover is coupled to the outer circumference of the cylinder.
